(19) United States
(12) Patent Application Publication
(10) Pub. No.: US 2015/0286252 A1
(43) Pub. Date: Oct. 8, 2015

(54) Docking Station Apparatus for a Portable Device

(71) Applicant: Antonino Giancola, Montreal (CA)

(72) Inventors: Massimo Barone, Laval (CA); Antonio Giancola, Montreal (CA); Steve Boa, Montreal (CA); Nick Chine, Montreal (CA); Abbondio Castronovo, Laval (CA)

(21) Appl. No.: 14/684,090

(22) Filed: Apr. 10, 2015

Related U.S. Application Data
(63) Continuation-in-part of application No. PCT/CA2013/000887, filed on Oct. 11, 2013.

(51) Int. Cl. G06F 1/16; G06F 13/40

(52) U.S. Cl. CPC G06F 1/1632; G06F 13/4081

(57) ABSTRACT

A docking station system for a portable device is disclosed. The docking station system may allow the usage of a smart electronic device such as a tablet, a netbook or any portative electronic device to record transactions and to process payment. The disclosed docking station system allows the easy removal and attachment of the smart electronic device, thus allowing other portable usages for the smart electronic device, such as controlling and managing other electronic devices, executing inventory related tasks or personal usage tasks.

### CROSS-REFERENCE TO RELATED APPLICATIONS

The present patent application is a continuation in part of international patent application PCT/CA2013/000887 entitled Docking Station Apparatus for a Portable Device and filed on Oct. 11, 2013 at the World International Property Organization which claims the benefits of priority of U.S. Provisional Patent Application No. 61/712,541, entitled “DOCKING STATION APPARATUS FOR A PORTABLE DEVICE” and filed at the United States Patents and Trademarks Office on Oct. 11, 2012.

### FIELD OF THE INVENTION

The present invention generally relates to apparatus and methods allowing the docking of portable devices and the remote connection of portable devices with docking station. More specifically, the present invention relates to docking apparatus for systems providing payment solution, and more specifically to docking systems for devices for payment solutions.

### BACKGROUND OF THE INVENTION

Recently, the offering of smart portable devices having a central processing unit (CPU), random access memory (RAM), storage device and touch screen have been increasing at a fast pace. The smart portable devices are useful for processing information or accessing wireless networks at any place and any time. However, such smart portable devices may not be easily placed or docked at a fixed location. Thus, there is a need for a docking apparatus allowing a portable smart device to be affixed at a predetermined location.

Furthermore, for the last decades, the retailers, markets and stores have typically used fixed cash registers or point of sale for recording commercial transactions of consumer purchases. Over the years, the cash registers systems have progressed from mechanical devices to electronic calculating cash registers to computerized cash register.

In such embodiments, the cash register is permanently fixed and operated by an employee or a cashier. Typically, the cash register system is assigned to store or even to a cashier desk and may not be moved or used in another location. Furthermore, the cash register is consigned to record transactions and process payments and may not be used for inventory purposes or for any usage required to a specific commerce. Thus, there is a need for a docking station allowing a point of sale or cash register device to be moved within a store and to automatically record commercial transactions.

### SUMMARY OF THE INVENTION

The aforesaid and other needs are realized by generally providing a docking station generally made of a rigid material, such as hard plastic, metal or wood being a host to a portable smart device. The docking station apparatus comprises a base, a vertical support beam, input/output (TO) connectors, a least one portable smart device attachment mean to the docking station apparatus and may comprise a display panel.

Furthermore, the docking station system may comprise a portable computing device having a display area, a main controller unit, an input/output router controller such as a USB hub router controller and a power supply unit. The main controller unit distributes and transfers data between the smart portable device and at least one input/output (I/O) connector.

A further aspect of this invention is to provide a docking station generally made of a rigid material, such as hard plastic, metal or wood being a host to a point of sale device such as a smart tablet, a smart phone or a netbook or any portable mobile device having at least the computing abilities smart phones or tablets. The docking station may comprise a card reader, a point of sale device support, a base, a vertical support beam, a least one smart device attachment mean to the docking station and a display panel.

Furthermore, to use the docking station system, a store owner preload the point of sale device with software or an application allowing transaction recording and payment processing. Then, the smart device is attached to the support using the at least one attachment mean. The smart device establishes communication with the main controller through the wireless communication controller. Once the communication is established, the smart device is ready to process payment or record transactions by a store employee or through a near field communication controller. A customer requiring to process a payment may read instructions through the display panel or through a personal electronic communication device.

According to an aspect of the present invention, a docking station system for a portable computer device is disclosed. The docking station system comprises a portable computing device secured to the docking station, the portable computing device executing a computer program to manage goods or services data. The docking station comprises a base portion, an arm member secured to the base portion, a portable computing device support secured to the arm member, a card reader secured to the portable computing device support, a display device, the display device displaying selected information retrieved from the docking station system, an input/output (I/O) router controller, a main controller unit, wherein the main controller unit is connected to the portable computing device, to the display device and to the at least one IO router controller and wherein the main controller is configured to process a payment from a customer portable computing device, and a power supply unit.

According to an aspect of the present invention, a method for using a docking station system for a portable computer device is disclosed. The method comprises attaching a portable computing device preloaded with a computer program to record transactions and process payment to a docking station. The docking station comprises a display device, the display device displaying selected information from the system, at least one input/output (I/O) router controller and a main controller unit. The method further comprising the step of communicating the data to record transactions and process payment between the portable computing device and a main controller through a communication controller and using the portable computer device to record transactions and process payment.

According to an aspect of the present invention, a method for using a docking station system for a portable computer device is disclosed. The method comprises attaching a portable computing device preloaded with a computer program to a docking station comprising a display device, at least one input/output (I/O) router controller and a main controller unit. The computer program typically allows communication between the portable communication device and the docking station. The method further comprising the steps of communicating the data to record transactions and process payment between the portable computing device and a main controller through a communication controller and using the portable computer device to record transactions and process payment.

The features of the present invention which are believed to be novel are set forth with particularity in the appended claims.

### BRIEF DESCRIPTION OF THE DRAWINGS

The above and other aspects, features and advantages of the invention will become more readily apparent from the following description, reference being made to the accompanying drawings in which:

FIG. 1 is a drawing of a docking station host in accordance with the present invention.

FIG. 2 is a schematic representation of the components of a docking station in accordance with the present invention.

FIG. 3 is a drawing of a docking station host in accordance with the present invention further comprising a portable computing device mounted therein.

FIG. 4 is a drawing of a docking station tray in accordance with an embodiment of the present invention further comprising a portable computing device mounted therein.

FIG. 5 is a drawing of a docking station tray in accordance with an embodiment of the present invention.

FIG. 6 is a drawing of a docking station host in accordance with the present invention further comprising a portable computing device mounted thereto.

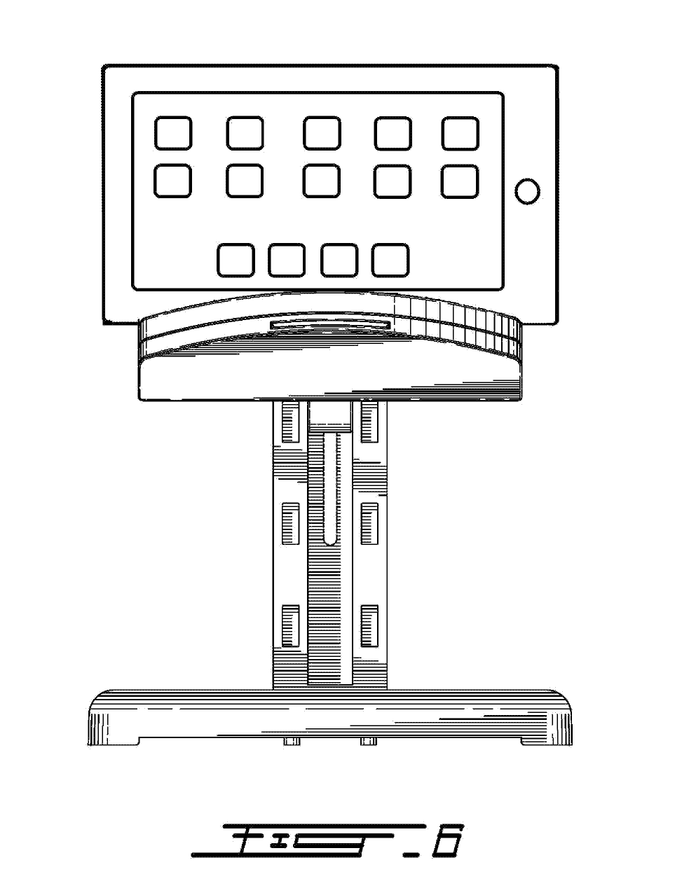

FIG. 7 is a customer view of a docking station host in accordance with the present invention.

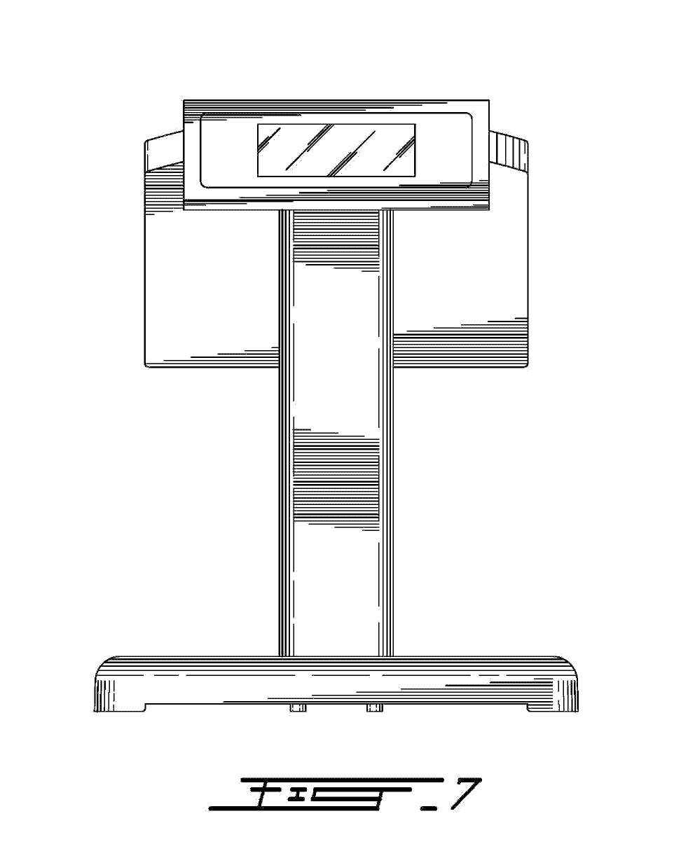

FIG. 8 is a perspective view of front facing and rear facing stand-alone apparatus comprising a portable computing device in accordance with the present invention.

### DETAILED DESCRIPTION OF THE PREFERRED EMBODIMENT

A novel docking station apparatus for a portable device will be described hereinafter. Although the invention is described in terms of specific illustrative embodiment(s), it is to be understood that the embodiments described herein are by way of example only and that the scope of the invention is not intended to be limited thereby.

In a first preferred embodiment, a docking station apparatus in accordance with the present invention allows the interfacing with portable smart device such as a portable computing device and more specifically as a tablet, a smart phone, a netbook, a pc tablet or any other computing device having portable capabilities to create a fixed location docking station. Such configuration would allow a portable smart device user to use the docking station to easily connect to other electronic devices, such as, but not limited to, one or more printing devices, one or more remote or local computers, one or more network such as remote or local networks or cloud access, to extend or duplicate the display to one or more monitor or to communicate with any compatible external device. The disclosed apparatus may also be used in a household for locking down or fixing the smart device, for data transferring or for managing other electronic devices or switches located within an enclosed location.

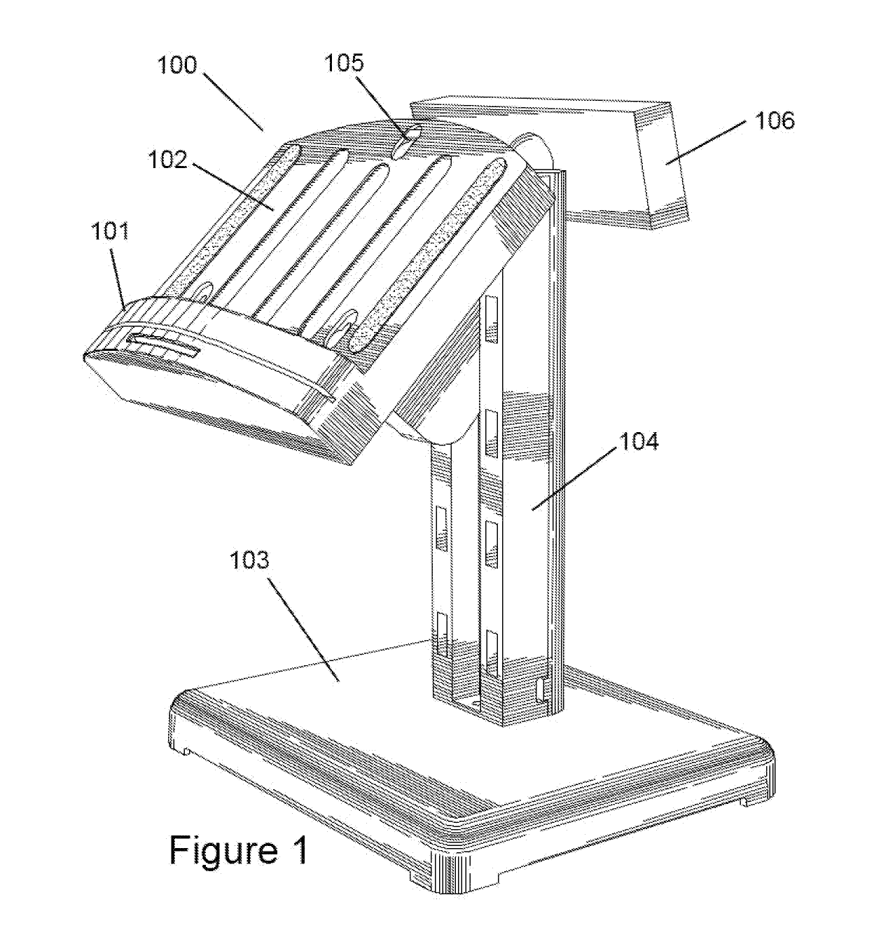

Referring to FIG. 1, the docking station apparatus 100 is made of rigid material such as hard plastic, metal or wood. The docking apparatus 100 may comprise a card reader 101 and a display panel 106, and comprises at least one smart device support 102, a base 103, a vertical support beam 104 and a least one portable smart device attachment mean to the docking apparatus 105. The card reader 101 allows reading of any payment card or payment method information, such as a magnetic card, a smart card or a chip-based card. In the first preferred embodiment, the smart device support 102 is inclinable and provides a means for adjusting its height. In a preferred embodiment, the smart device support 102 configuration may be secured by tightening an attachment mean, such as a knob or both, to lock the support 102 in place. The base 103 typically comprises a frame, at least one weight to maintain balance, such as metal weights, and, if required, an attaching means to secure the base to any surface, such as a counter top or the floor. The vertical support beam 104 upwardly extends from the base and allows the concealing of at least one cable, such as the power supply cable. Furthermore, the vertical support beam 104 supports the smart device support 102.

In another embodiment, the vertical support beam 104 may be replaced with an arm allowing movement in different directions. In this configuration, the smart device support 102 is attached or affixed to the arm. The attachment mean of the smart device support 102 to the arm may provide inclination or rotation movement. Such an arm may comprise one or more joints or ball joints in order to provide further spatial location of the smart device support 102. In a further embodiment, the vertical support beam may be replaced with any mean allowing the support of the smart device support 102 or allowing the height adjustment of the smart device support 102. One skilled in the art shall understand that any mean for adjusting the height, such as a sliding mechanism comprising a locking mean or a locking pivoting arm may be used.

The at least one attachment mean to the docking station 105 locks the portable smart device to the docking station 100, thus preventing the portable smart device from falling from the docking station 100 or being stolen when unattended. In a first preferred embodiment, the attachment mean 105 comprises at least 3 point attaching system allowing easy removal of the smart portable device, thus keeping the portable usages of the smart portable device.

In the first preferred embodiment, the display panel 106 is attached on the upper portion of the vertical support beam 104. The display panel 106 may be horizontally or vertically adjusted to allow a smart portable device user to obtain a preferred angle. Furthermore, the docking station may comprise a near field communication controller (not shown) allowing a use to use a smart portable device to communicate with any other device or computer server within a predetermined radius of the near field communication controller. The electronic communication device may be embodied as any device supporting the near field communication protocol, such as but not limited to, a mobile phone, a smart phone or a tablet.

In other embodiments, the display panel 106 forms a single unit with the vertical support beam 104, an arm or any other supporting mean or may be directly attached to the point of sale support 102. In a further embodiment, the display panel 106 may be configured to be removable from the docking apparatus 100.

In a second preferred embodiment, a docking apparatus 100 in accordance with the present invention comprising the same features as a docking apparatus 100 described in a first preferred embodiment but further allowing the interface with a smart device configured as a point of sale device, such as a portable computing device and more specifically as a tablet, a smart phone, a netbook, a pc tablet or any other computing device interfacing with a docking station to create a system have the features of a point of sale system. Such portable computing device typically comprises a display area for displaying information. Such display area is generally touch sensitive and allow the interaction with the portable computing device.

Still referring to FIG. 1, the docking station 100 is made of a rigid material such as hard plastic, metal or wood. The docking station 100 further comprises a card reader 101 and a display panel 106. The card reader 101 allows reading of any card storing payment information, such as a magnetic card, a smart card or a chip-based card.

As in a first preferred embodiment, the at least one attachment mean to the docking station 105 locks the point of sale device to the docking station 100, thus preventing the device from falling from the docking station 100 or being stolen when unattended. The attachment mean comprises at least 3 point attaching system allowing easy removal of the point of sale device, thus enabling other usages of the point of sale device, such as inventory control or other store-related tasks.

In the preferred embodiment, the display panel 106 is attached on the upper portion of the vertical support beam 104. The display panel 106 may be horizontally or vertically adjusted to allow a customer to obtain a preferred angle. Furthermore, the docking station may comprise a near field communication controller (not shown) allowing a customer to pay by having an electronic communication device within a predetermined radius of the near field communication controller. The electronic communication device may be embodied as any device supporting the near field communication protocol, such as but not limited to, a mobile phone, a smart phone or a tablet.

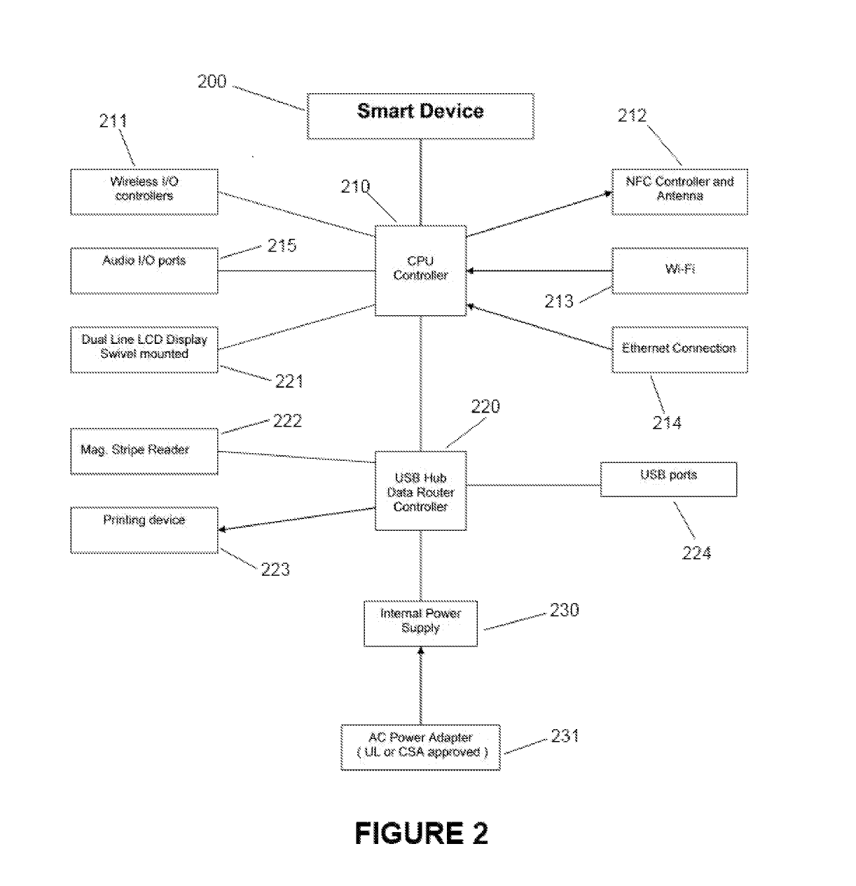

Now referring to FIGS. 1-3, the docking station system components and their relations are shown. The docking station system 100 comprises a portable computing device 200, a main controller unit 210 and an input/output router controller 220, such as, but not limited to, a USB hub router controller and a power supply unit 230. The main controller unit 210 distributes and transfers data between the portable smart device 200 and at least one input/output (I/O) devices, such as a keypad, a code reader, a magnetic stripe reader 222, an display device 221, such as a LCD display or a LED display, or a printing device 223. Generally, the main controller 210 is embodied as a computer device comprising a central processing unit (CPU), a memory unit, a storage unit and an operating system (OS) such as, but not limited to, Linux™, Windows™, Android™, OSX™ or UNIX™. In other embodiments, the main controller 210 may be embodied as a mini personal computer, a server computer or a custom electronic circuit allowing the processing of data. The main controller unit 210 uses a wireless connections controller 211 to manage wireless connections, such as Bluetooth™ or Wi-FI connections. The main controller 210 manages the display panel 221 mounted on the vertical support beam 104, the near field communication controller 212, which typically comprises an antenna and allows a customer electronic device to quickly processes a payment. In another embodiment, the display panel may be mounted to provide swivel movement. Also, the main controller 210 controls a connection of the docking station system to a computer network 214, such a local area network (LAN), a wide area network (WAN) or the Internet. Furthermore, the main controller may manage at least one audio input and output through at least one audio connector or port 215, such as a 3.5 mm audio connector or an audio-video port such as RCA or HDMI ports.

The input/output router controller 220 controls the different interfaces to internal and external I/O connectors, such as internal and external card swiping devices 222, printing device 223 or a plurality of general I/O ports 224, such as USB ports or any other standard or custom data ports.

The power supply unit 230 provide electrical power alimentation to the docking station system 100. In the preferred embodiment, the power supply unit 230 comprises an AC power adapter 231 to convert alternative current to direct current to power the plurality of electronic components. In other embodiments, the power supply unit 230 may be integrated to the main controller unit 210.

Still referring to FIGS. 1-3, typically, to use the docking station system, a store owner preloads the portable smart device 200 with software or an application allowing transaction recording and payment processing or allowing communication with the docking apparatus 100. Then, the portable smart device 200 is attached to the support 104 using the at least one attachment mean 105. The point of sale device 200 establishes communication with the main controller 210 through the wireless communication controller 211. Once the communication is established, the portable smart device 200 is ready to process data transmitted by the docket apparatus 100. In some embodiment, the portable smart device 200 shall be configured or programmed to process payment, record transactions, through a store employee or a near field communication controller 213 by entering payment data through a magnetic stripe reader 222 or through a wireless connection 213 from the customer's portable smart device. Once the payment information is processed by the docket apparatus 100, the payment information is communicated to the portable smart device 200 through any of the I/O connectors, such as an I/O port 224, a wireless connection 213 or a network connection 214. The portable smart device 200 must be configured or programmed to validate the payment information and to process one or more transactions. A customer requiring the processing of a payment may read instructions through the display panel 106 or through a personal electronic communication device.

At any time, an employee of the store or a user may easily remove the portable smart device 200 in order to use the device 200 for other tasks, such as inventory purposes, or to be removed when the employee shift is over or for any tasks required by the commerce. To resume the transaction recording process, the device 200 may be attached to the docking station support 102 by sliding the device 200 through the attaching system 105.

In other embodiments, the docking station system 100 may be used to charge or to transfer data to the portable smart device 200.

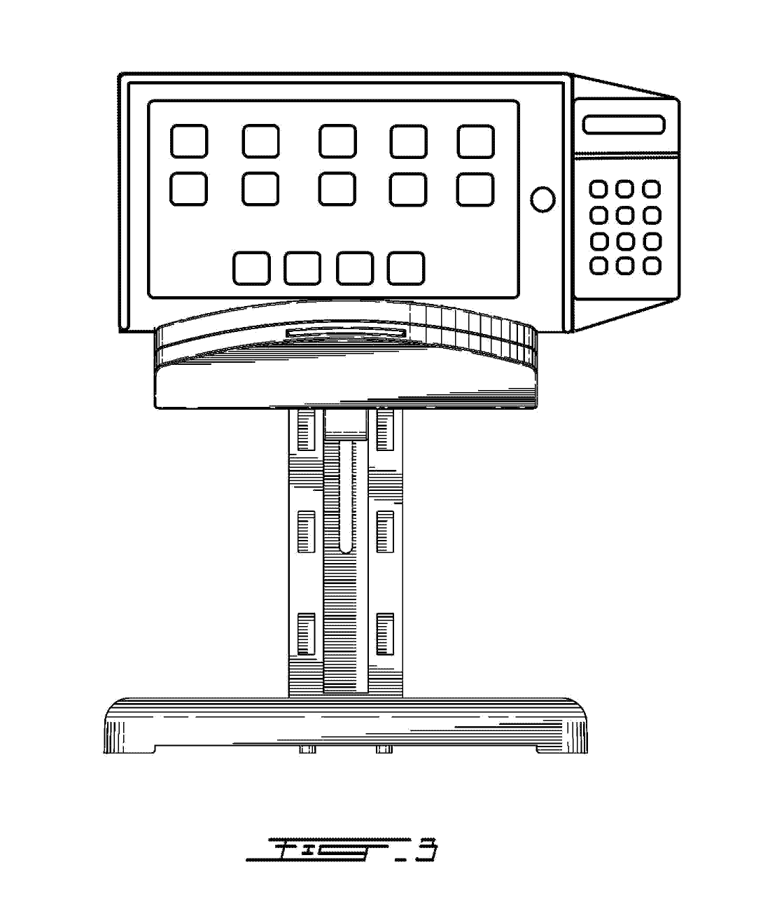

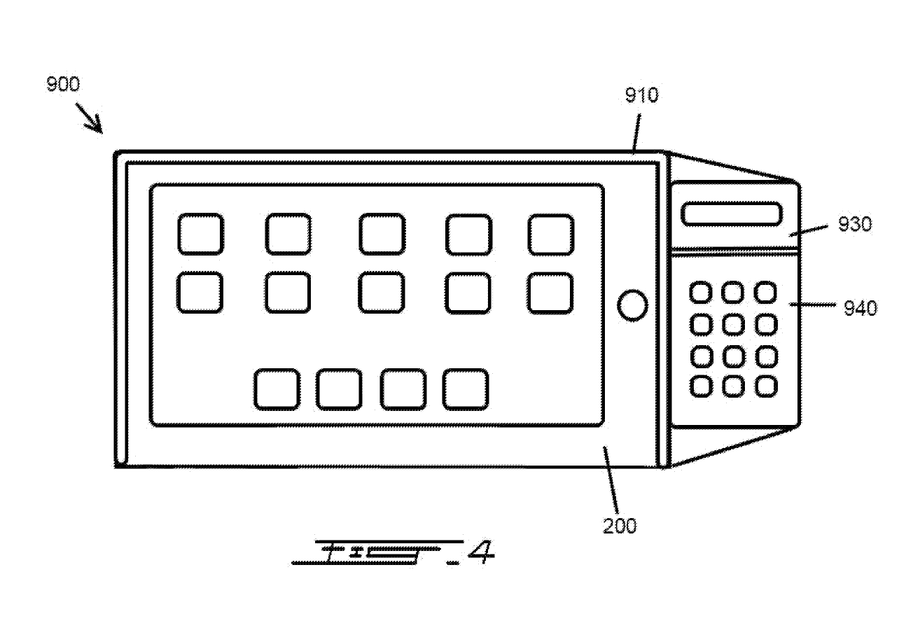

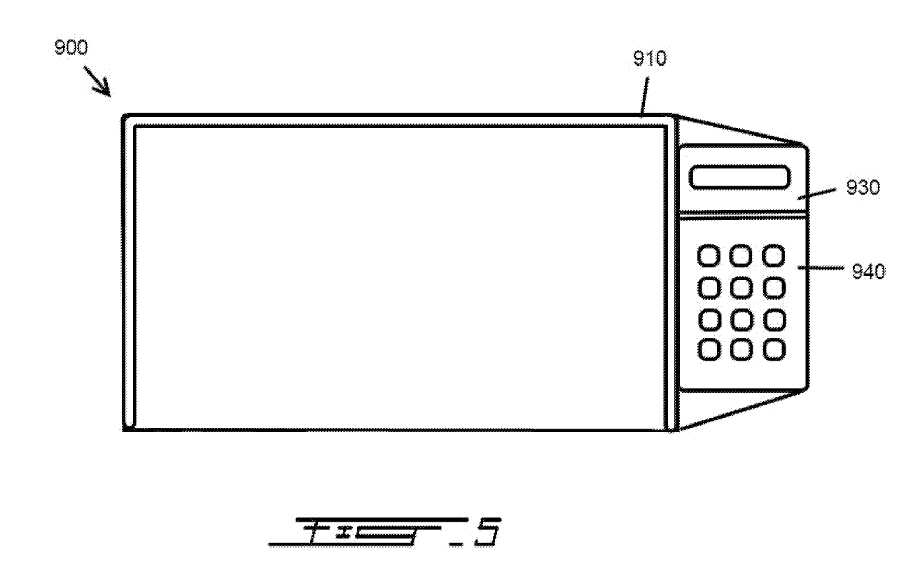

Now referring to FIG. 3-5, in another embodiment, the docking station system 100 may further comprise a tray member 900 The tray member 900 is built in a manner that allow attachment of the portable computing device 200 therein. The tray member 900 comprises a main frame 910, and a docking attachment member. As such, the tray member 900 allows the user to use the tray member 900 and the portable computing device attached therein in a portable manner. Consequently, it is possible for the user to serve clients in a store while having the portable computing device 200 and the tray member 900 attached thereto. Furthermore, the tray member 900 may comprise a card reader 930 in combination with an optional keypad 940. Such an embodiment allow the user to serve a client wherever the client is in the store while having the ability to process a payment. When processing a payment, the card reader 930 and keypad 940 may communicate directly with the docking station 110 using wireless connections or may communicate to the portable computing device 200 attached to the tray main frame. The optional character of the keypad 940 stem from the ability of some portable computing device 200 to display such a keypad 940. However, in some instances, the keypad 940 is required. Such instances comprises instances where the processing of the payment requires the use NIP enable card chip. Accordingly, the Europay, MasterCard and Visa (EMV) global standard for inter-operation of integrated circuit cards (IC cards or “chip cards”) and IC card capable point of sale (POS) terminals and automated teller machines (ATMs), for authenticating credit and debit card transactions may require the use of such a keypad 940 independent of the portable computing device 200. Such a requirement may originate from the security protocols of the payment EMV standards.

Still referring to FIGS. 3-5, the docking station 100 in accordance with an embodiment may be used with the tray member 900 attached thereto or may be used while the tray member 900 is not attached thereon. In cases where the tray member 900 is attached to the docking station support 102, the tray member 900 may communicate to the docking station 100 using wireless communications. For use of the device 200 while attached to the docking station support 102, the tray member 900 may be in wired or wireless communication with the docket station system 100. In addition, the user will have the option to display the transaction information while the tray member 900 is removed from the docking station support 102.

In yet another embodiment, the docking station 100 may be embodied as a stand alone apparatus such as a box made of rigid material. In such an embodiment, the stand alone apparatus comprises I/O connectors a for the docking station 100 embodiment,

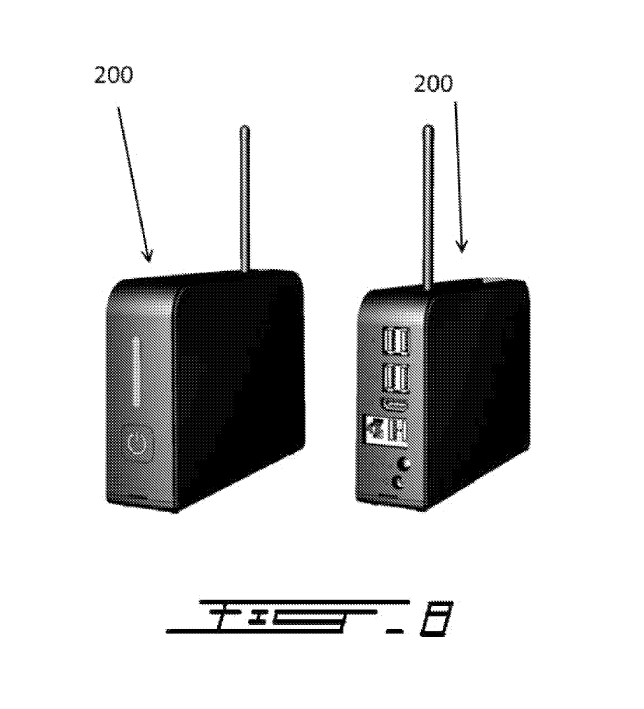

Now referring to FIG. 8, similarly to the docking station embodiment, the stand alone apparatus comprises a portable computing device 200, a main controller unit 210 and an input/output router controller 220, such as, but not limited to, a USB hub router controller and a power supply unit 230. The main controller unit 210 distributes and transfers data between the portable smart device 200 and at least one input/output (I/O) devices, such as a keypad, a code reader, a magnetic stripe reader 222, an display device 221, such as a LCD display or a LED display, or a printing device 223. Generally, the main controller 210 is embodied as a computer device comprising a central processing unit (CPU), a memory unit, a storage unit and an operating system (OS) such as, but not limited to, Linux™, Windows™, Android™, OSX™ or UNIX™. In other embodiments, the main controller 210 may be embodied as a mini personal computer, a server computer or a custom electronic circuit allowing the processing of data. The main controller unit 210 uses a wireless connections controller 211 to manage wireless connections, such as Bluetooth™ or Wi-FI connections. The main controller 210 manages the near field communication controller 212, which typically comprises an antenna and allows a customer electronic device to quickly processes a payment. Also, the main controller 210 controls a connection of the system to a computer network 214, such a local area network (LAN), a wide area network (WAN) or the Internet. Furthermore, the main controller may manage at least one audio input and output through at least one audio connector or port 215, such as a 3.5 mm audio connector or an audio-video port such as RCA or HDMI ports.

The input/output router controller 220 controls the different interfaces to internal and external I/O connectors, such as an external card swiping devices 222, printing device 223 or a plurality of general I/O ports 224, such as USB ports or any other standard or custom data ports.

The power supply unit 230 provides electrical power alimentation to the stand alone apparatus. In the preferred embodiment, the power supply unit 230 comprises an AC power adapter 231 to convert alternative current to direct current to power the plurality of electronic components. In other embodiments, the power supply unit 230 may be integrated to the main controller unit 210.

In such an embodiment, the apparatus may be configured to remotely connect with an independent module comprising a card swiping device and being configured to securely communicate the card information to the apparatus through a communication method, such as wireless communication protocol or a wired communication protocol. Furthermore, the card swiping device may be embodied as a docking station being separated from the apparatus. In such an embodiment, the docking station comprises a card swiping or card reading device (such as RFID or NFC) and is configured to remotely communicate the information to the stand alone apparatus. One skilled in the art shall understand that such an embodiment allows to separate the POS processing solution from the physical docking station, thus increasing the portability and inter-changeability of the POS solution with respect to the docking station.

In other embodiment of the stand alone apparatus, the apparatus may be configured to be used as a streaming audio video content device, a kiosk marketing controller, a smart home central controller, media, a digital signage device, a consumer tracker, a couponing controller, a Wi-Fi Hot Spot Controller, a human interface controller, an email harvesting device, an SMS harvesting device, a Web Interface, a local central gaming controller and a promotional broadcasting system. One skilled in the art shall understand that such an apparatus provides easy configuration and flexibility, thus, the apparatus may be configured for other similar purposes using the I/O controller and ports, and the main processing unit to execute customized tasks.

In an embodiment wherein the apparatus is configured as a media box, the apparatus comprises a media steaming controller for digital signage of multimedia content, including audio and video content. The media box may be further configured to provide encryption or secure communication to a remote storage location, such as cloud-based solution or remote data centers to access the media. The apparatus may be connected or in communication with a user-interaction module, such as a touch screen or a screen connected to an input device, such as a mouse and/or a keyboard.

In a further embodiment of the apparatus configured as a kiosk, the apparatus further comprises a controller for digitally signing or reading audio and video content and to stream marketing information to remote users or remote devices. The apparatus may be further configured to capture information about the user or device accessing the marketing information. The apparatus may be connected or in communication with a user-interaction module, such as a touch screen or a screen connected to an input device, such as a mouse and/or a keyboard.

In a further embodiment, the apparatus may be configured as digital consumer tracking and couponing solution. In such an embodiment, the digital consumer tracking apparatus further comprises a module for locating, storing and/or managing client profile such as consumer information, consumer product preferences and/or product rebates or deals. The apparatus is typically configured to access fetch information from local or cloud-based storage device in order to access to client profiles or external rebates or coupons.

In a further embodiment, the apparatus may comprise a code scanner for scanning an identifier containing information. The identifier may be configured to be single or multiple use. Embodiments of an identifier comprise printed or displayed codes such as barcode, 2D or 3D code, QR code or redemption barcodes data. Alternatively, the data of such identification codes may be entered on a local or mobile device to determine its purpose. The coupons data is preferably verified through an external third party or cloud based database to verify the validity of the coupon and to identify the value of the coupons. Once the coupon data is verified and validated, the local system shall redeem the value associated with the coupon and input the value in the local POS or other accounting software in order to calculate the value or amount deduced from the redeemed coupon value. Based on the type of coupon to be redeemed, the treatment of the coupon by the management system or POS shall be adapted accordingly. In the case of a single use coupon, the coupon will be automatically deleted from the client mobile devices data. Whereas in the case of a paper copy, the copy may be destroyed or conserved depending on organizational policies.

In yet another embodiment, the apparatus may be configured as a universal smart home controller. In such an embodiment, the apparatus further comprises a graphical user interface for home smart devices and automation devices. The apparatus is configured to interface with other apparatuses such as television, other computing devices, tablets, smart phones and any other smart devices. In such an embodiment, the apparatus is configured to remotely or locally manage the smart devices. As such, the apparatus may be configured to provide a web interface or a communication link with an application installed on a remote device in order to remotely manage the smart devices. The apparatus may be further configured to track and store the actions and events of the connected smart device as to allow identification of trends and habits and to predict and configure the connected smart devices with regards to the predictions and identified trends.

In another embodiment, the apparatus may be configured to provide an increased range of wireless connection in areas where network connection is merely or not available. In such an embodiment, the central controller is configured to find or seek and to connect to an available wireless network connection. The network module is then configured to share the wireless network connection. The sharing may be configured using any known method such as configuring a software router or using network sharing mechanisms. At least one of the other apparatus must be configured to connect to a remote network. The other apparatus seeks and finds the shared remote network and connect to it in order to access the network. The concept may be reproduced on other apparatus, thus, creating a daisy chain of apparatus sharing the network connection.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A docking station system for a portable computer device, the docking station system comprising:
a) a portable computing device removably secured to the docking station, the portable computing device comprising a display area and executing a computer program to manage goods or services data;
b) a docking station comprising:
i) a base portion;
ii) an arm member secured to the base portion;
iii) a portable computing device support secured to the arm member;
iv) a card reader secured to the portable computing device support;
v) a display device, the display device displaying selected information retrieved from the docking station system and facing a substantial opposite direction to the display area of the portable computing device;
vi) at least one input/output (I/O) router controller;
vii) a main controller unit, the main controller unit being in communication with the portable computing device, with the display device and with the at least one I/O router controller and the main controller being configured to process a payment from a customer portable computing device; and
viii) a power supply unit connected to an electrical source powering electric power to the docking station system.

2) A docking station system for a portable computer device as claimed in claim 1, the portable computing device being loaded with a computer program to proceed an inventory.

3) A docking station system for a portable computer device as claimed in claim 1, the computer program to manage goods and services data being configured to store transaction and to process payment; and the payment information being displayed on the display device.

4) A docking station system for a portable computer device as claimed in claim 1, the portable computing device being configured to act as a point of sale system.

5) A docking station system for a portable computer device as claimed in claim 1, the docking station system comprising a near field communication (“NFC”) controller and being configured with another portable computing device located within a predetermined radius of the NFC controller, the another portable computing device being configured to communicate data about goods or services to be paid.

6) A docking station system for a portable computer device as claimed in claim 1, the power supply unit comprising a module to supply power to the portable computing device.

7) A docking station system for a portable computer device as claimed in claim 1, the main controller being a computer device comprising a central processing unit (CPU), a memory unit, a storage unit and an operating system.

8) A method for using a docking station system for a portable computer device, the method comprising:
a) attaching a portable computing device having a display area and preloaded with a computer program to record transactions and process payment to a docking station, the docking station comprising:
i) a display device, the display device displaying selected information from the system;
ii) at least one input/output (I/O) router controller;
iii) a main controller unit;
b) communicating the data to record transactions and process payment between the portable computing device and a main controller through a communication controller;
c) using the portable computer device to record transactions and process payment.

9) A method for using a docking station system for a portable computer device as claimed in claim 8, wherein the portable computer device is programmed to process payment and record transactions through a store employee entering the payment data using a card reader.

10) A method for using a docking station system for a portable computer device as claimed in claim 9, wherein the portable computer communicates with another computer portable device using near field communication controller.

11) A method for using a docking station system for a portable computer device as claimed in claim 8, wherein the payment information is communicated to the portable computing device through the at least one I/O connector.

12) A method for using a docking station system for a portable computer device as claimed claim 8, wherein the payment information is communicated to the portable computer device through a network connection.

13) A method for using a docking station system for a portable computer device as claimed claim 8, wherein the portable computing device validates the payment information.

14) A method for using a docking station system for portable computer device as claimed in claim 8, wherein the portable computing device validates the payment information and processes at least one transaction.

15) A method for using a docking station system for a portable computer device as claimed in claim 8, wherein the docking station further displays the instructions for processing the payment on the display device.

16) A method for using a docking station system for a portable computer device as claimed in claim 8, wherein the docking station further displays on the display device the instructions for processing the payment on a portable computer device.

17) A method for using a docking station system for a portable computer device as claimed claim 8, the method further comprising:
a) removing the portable computing device from the docking station; and
b) using the portable computing device for inventory purposes.

18) A method for using a docking station system for a portable computer device as claimed in claim 21, wherein the step to remove the portable computing device from the docking station stops the transaction recording process.

19) A method for using a docking station system for a portable computer device as claimed in claim 22, wherein the transaction recording process is resumed by attaching the portable computing device to the docking station.

20) A method for using a docking station system for a portable computer device, the method comprising:
a) attaching a portable computing device having a display area and being preloaded with a computer program to a docking station comprising:
i) a display device;
ii) at least one input/output (I/O) router controller;
iii) a main controller unit;
wherein the computer program allows communication between the portable communication device and the docking station;
b) communicating the data to record transactions and process payment between the portable computing device and a main controller through a communication controller;
c) using the portable computer device to record transactions and process payment.

21) A method for using a docking station system for a portable computer device as claimed in claim 20, wherein the portable computer device is programmed to process payment and record transactions through a store employee entering the payment data using a magnetic stripe reader.

22) A method for using a docking station system for a portable computer device as claimed in claim 20, wherein the portable computing device is programmed to process payment and record transactions through a near field communication controller using a wireless connection from a customer's portable computing device.

23) A method for using a docking station system for a portable computer device as claimed claim 20, wherein the payment information is communicated to the portable computing device through the at least one I/O connector.

24) A method for using a docking station system for a portable computer device as claimed in claim 20, wherein the payment information is communicated to the portable computing device through a network connection.

25) A method for using a docking station system for a portable computer device as claimed in claim 20, wherein the portable computing device validates the payment information.

26) A method for using a docking station system for a portable computer device as claimed in claim 20, wherein the portable computing device validates the payment information and processes at least one transaction.

27) A method for using a docking station system for a portable computer device as claimed in claim 20, wherein the docking station further displays the instructions for processing the payment on the display device.

28) A method for using a docking station system for a portable computer device as claimed in claim 20, wherein the docking station further displays the instructions for processing the payment on a personal electronic communication device.

29) A method for using a docking station system for a portable computer device as claimed in claim 20, the method further comprising the steps of:
a) removing the portable computing device from the docking station; and
b) loading a computer program on the portable device to execute an inventory.

30) A method for using a docking station system for a portable computer device as claimed in claim 29, wherein the removal of the portable computing device from the docking station stops the transaction recording process.

31) A method for using a docking station system for a portable computer device as claimed claim 30, wherein the transaction recording process is resumed by attaching the portable computing device to the docking station.
